(19) United States
(12) Patent Application Publication
(10) Pub. No.: US 2023/0159750 A1
(43) Pub. Date: May 25, 2023

(54) POLYURETHANE RESIN AND METHOD FOR PRODUCING THE SAME

(71) Applicant: NAN YA PLASTICS CORPORATION, Taipei (TW)

(72) Inventors: TE-CHAO LIAO, TAIPEI (TW); SEN-HUANG HSU, TAIPEI (TW); CHUAN CHOU, TAIPEI (TW)

(21) Appl. No.: 17/886,835

(22) Filed: Aug. 12, 2022

(30) Foreign Application Priority Data
Nov. 23, 2021 (TW) 110143477

(51) Int. Cl. C08L 75/08; C08G 18/12; C08G 18/22; C08G 18/32; C08G 18/48; C08G 18/80

(52) U.S. Cl. CPC C08L 75/08; C08G 18/12; C08G 18/227; C08G 18/3206; C08G 18/4825; C08G 18/4829; C08G 18/4833; C08G 18/4854; C08G 18/807

(57) ABSTRACT

A polyurethane resin and a method for producing the same are provided. The method includes a first polymer forming step implemented by reacting a first polyether polyol and an isocyanate to form a first polymer, a second polymer forming step implemented by reacting the first polymer and a second polyether polyol to form a second polymer, and a blocking step implemented by adding a blocking agent into the second polymer to form the polyurethane resin. A hydroxyl functionality of the first polyether polyol is less than a hydroxyl functionality of the second polyether polyol. A usage amount ratio of a usage amount of the first polyether polyol to a usage amount of the second polyether polyol to a usage amount of the blocking agent is within a range from 35:59:6 to 27:70:3. A degree of crosslinking of the polyurethane resin is within a range from 2.2 to 2.5.

### CROSS-REFERENCE TO RELATED PATENT APPLICATION

This application claims the benefit of priority to Taiwan Patent Application No. 110143477, filed on Nov. 23, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyurethane resin and a method for producing the same, and more particularly to a polyurethane resin that is applicable to vehicle leather and a method for producing the same.

### BACKGROUND OF THE DISCLOSURE

Generally, a blocking agent is added in a conventional polyurethane resin, so that an isocyanate group (—NCO) in the conventional polyurethane resin is prevented from reacting in a normal temperature environment. If the isocyanate group in the conventional polyurethane resin has a reaction, the conventional polyurethane resin cannot exhibit its original property.

However, in order to avoid the above problem, an excessive amount of the blocking agent is often added into the conventional polyurethane resin. As a result, the conventional polyurethane resin has excessive bubbles, a poor low-temperature bending resistance, and an unpleasant odor.

Therefore, how to improve the conventional polyurethane resin and a method for producing the same, so as to overcome the above-mentioned deficiency, has become one of the important issues to be solved in the field.

### SUMMARY OF THE DISCLOSURE

In response to the above-referenced technical inadequacy, the present disclosure provides a polyurethane resin and a method for producing the same, so as to improve a conventional polyurethane resin prone to having excessive bubbles, a poor low-temperature bending resistance, and an unpleasant odor due to being added with an excessive amount of blocking agent.

In one aspect, the present disclosure provides a method for producing a polyurethane resin. The method includes a first polymer forming step, a second polymer forming step, and a blocking step. The first polymer forming step is implemented by reacting a first polyether polyol and an isocyanate to form a first polymer. The second polymer forming step is implemented by reacting the first polymer and a second polyether polyol to form a second polymer. A hydroxyl functionality of the first polyether polyol is less than a hydroxyl functionality of the second polyether polyol. The blocking step is implemented by adding a blocking agent into the second polymer to form the polyurethane resin. A usage amount ratio of a usage amount of the first polyether polyol to a usage amount of the second polyether polyol to a usage amount of the blocking agent is within a range from 35:59:6 to 27:70:3. A degree of crosslinking of the polyurethane resin is within a range from 2.2 to 2.5.

In certain embodiments, based on 100 parts by weight of the polyurethane resin, the usage amount of the first polyether polyol is 25 to 35 parts by weight, a usage amount of the isocyanate is 8 to 14 parts by weight, the usage amount of the second polyether polyol is 45 to 65 parts by weight, and the usage amount of the blocking agent is 3 to 6 parts by weight.

In certain embodiments, in the second polymer forming step, a chain extender further is added, and the first polymer, the second polyether polyol, and the chain extender jointly react and form the second polymer. Based on 100 parts by weight of the polyurethane resin, a usage amount of the chain extender is 0 to 3 parts by weight. The chain extender is at least one selected from the group consisting of ethylene glycol, 1,4-butanediol, and 1,6-hexanediol.

In certain embodiments, the hydroxyl functionality of the first polyether polyol is 2, and the hydroxyl functionality of the second polyether polyol is within a range from 3 to 4.

In certain embodiments, the hydroxyl functionality of the second polyether polyol is 3.

In certain embodiments, a number average molecular weight of the first polymer is within a range from 10,000 to 20,000, and a number average molecular weight of the second polymer is within a range from 20,000 to 30,000.

In certain embodiments, the second polyether polyol is further limited to being a long chain polyether polyol, the second polyether polyol includes a plurality of repeating units, and each of the repeating units is at least one selected from the group consisting of ethylene glycol, propylene glycol, and butylene glycol. A quantity of the repeating units included in the second polyether polyol is within a range from 10 to 110.

In certain embodiments, the first polyether polyol is at least one selected from the group consisting of ethylene glycol, propylene glycol, and butylene glycol, the isocyanate is at least one selected from the group consisting of diphenylmethane diisocyanate, toluene diisocyanate, and isophorone diisocyanate, and the second polyether polyol is at least one selected from the group consisting of polyethylene glycol, polypropylene glycol, and polybutylene glycol.

In another aspect, the present disclosure provides a polyurethane resin. The polyurethane resin includes a first polyether polyol, an isocyanate, a second polyether polyol, and a blocking agent. A hydroxyl functionality of the first polyether polyol is less than a hydroxyl functionality of the second polyether polyol. A usage amount ratio of a usage amount of the first polyether polyol to a usage amount of the second polyether polyol to a usage amount of the blocking agent is within a range from 35:59:6 to 27:70:3. A degree of crosslinking of the polyurethane resin is within a range from 2.2 to 2.5.

In certain embodiments, based on 100 parts by weight of the polyurethane resin, the usage amount of the first polyether polyol is 25 to 35 parts by weight, a usage amount of the isocyanate is 8 to 14 parts by weight, the usage amount of the second polyether polyol is 45 to 65 parts by weight, and the usage amount of the blocking agent is 3 to 6 parts by weight.

In certain embodiments, the polyurethane resin further includes a chain extender. Based on 100 parts by weight of the polyurethane resin, a usage amount of the chain extender is 0 to 3 parts by weight. The chain extender is at least one selected from the group consisting of ethylene glycol, 1,4-butanediol, and 1,6-hexanediol.

In certain embodiments, the hydroxyl functionality of the first polyether polyol is 2, and the hydroxyl functionality of the second polyether polyol is within a range from 3 to 4.

In certain embodiments, the hydroxyl functionality of the second polyether polyol is 3.

In certain embodiments, the second polyether polyol is further limited to being a long chain polyether polyol, the second polyether polyol includes a plurality of repeating units, and each of the repeating units is at least one selected from the group consisting of ethylene glycol, propylene glycol, and butylene glycol. A quantity of the repeating units included in the second polyether polyol is within a range from 10 to 110.

In certain embodiments, the first polyether polyol is at least one selected from the group consisting of ethylene glycol, propylene glycol, and butylene glycol, the isocyanate is at least one selected from the group consisting of diphenylmethane diisocyanate, toluene diisocyanate, and isophorone diisocyanate, and the second polyether polyol is at least one selected from the group consisting of polyethylene glycol, polypropylene glycol, and polybutylene glycol.

Therefore, in the polyurethane resin and the method for producing the same provided by the present disclosure, by virtue of a hydroxyl functionality of the first polyether polyol being less than a hydroxyl functionality of the second polyether polyol, and a usage amount ratio of a usage amount of the first polyether polyol to a usage amount of the second polyether polyol to a usage amount of the blocking agent being within a range from 35:59:6 to 27:70:3, the polyurethane resin that is finally formed can exhibit properties such as having few bubbles, an excellent low-temperature bending resistance, and a low odor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawing, in which:

FIG. 1 is a flowchart of a method for producing a polyurethane resin according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Method for Producing a Polyurethane Resin

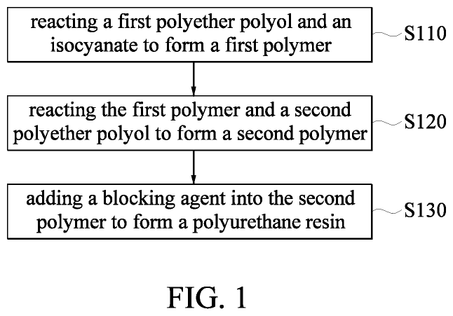

Referring to FIG. 1, FIG. 1 is a flowchart of a method for producing a polyurethane resin according to an embodiment of the present disclosure. The present disclosure provides a method for producing a polyurethane resin. The method for producing the polyurethane resin includes a first polymer forming step S110, a second polymer forming step S120, and a blocking step S130.

The first polymer forming step S110 is implemented by reacting a first polyether polyol and an isocyanate to form a first polymer.

The second polymer forming step S120 is implemented by reacting the first polymer and the second polyether polyol to form a second polymer.

The blocking step S130 is implemented by adding a blocking agent into the second polymer to form the polyurethane resin, and a degree of crosslinking of the polyurethane resin is within a range from 2.1 to 2.7. Furthermore, after the blocking step S130, the polyurethane resin is a blocked polyurethane resin. It is worth mentioning that, in the method for producing the polyurethane resin of the present disclosure, the degree of crosslinking of the polyurethane resin is adjusted to be within a range from 2.2 to 2.5 primarily through adding the second polyether polyol. When the degree of crosslinking is high, a low-temperature bending resistance of the polyurethane resin is poor. Therefore, the degree of crosslinking of the polyurethane resin should not be too high. In addition, the polyurethane resin produced by such a method can be applied to vehicle leather, but the present disclosure is not limited thereto.

In the polyurethane resin, a usage amount ratio among a usage amount of the first polyether polyol, a usage amount of the second polyether polyol, and a usage amount of the blocking agent is within a range from 35:59:6 to 27:70:3.

A hydroxyl functionality of the first polyether polyol is less than a hydroxyl functionality of the second polyether polyol. Preferably, the hydroxyl functionality of the first polyether polyol is 2, and the hydroxyl functionality of the second polyether polyol is within a range from 3 to 4. More preferably, the hydroxyl functionality of the first polyether polyol is 2, and the hydroxyl functionality of the second polyether polyol is 3. In other words, the first polyester polyol can be a polyether glycol, and the second polyester polyol can be a polyether triol, but the present disclosure is not limited thereto.

In the method for producing the polyurethane resin of the present disclosure, the first polyether polyol having a relatively low hydroxyl functionality is reacted, and then the second polyester polyol having a relatively high hydroxyl functionality is reacted. Through cooperation with the usage amount ratio among the usage amount of the first polyester polyol, the usage amount of the second polyester polyol, and the usage amount of the blocking agent, the usage amount of the blocking agent can be reduced, and the polyurethane resin can exhibit excellent properties (e.g., few bubbles, an excellent low-temperature bending resistance, and a low odor).

It is worth mentioning that, in the method for producing the polyurethane resin, if the second polyester polyol reacts with the isocyanate before the first polyester polyol reacts with the isocyanate, the polyurethane resin that is finally formed has a relatively poor fluidity, thereby causing the polyurethane resin to have a relatively poor processability. Therefore, the first polymer forming step S110 is preferably implemented before the second polymer forming step S120.

In addition, the blocking agent can prevent an isocyanate group (—NCO) of the polyurethane resin from easily reacting under a normal temperature, so that the properties of the polyurethane resin are not affected by the reaction of the isocyanate group. In the method for producing the polyurethane resin, if only the first polyether polyol is added and the second polyurethane resin is not added, the usage amount of the blocking agent should be relatively high. As a result, the finally formed polyurethane resin has issues that include too many bubbles, a poor low temperature-bending resistance, and an unpleasant odor.

In terms of the usage amount, based on 100 parts by weight of the polyurethane resin, the usage amount of the first polyether polyol is 25 to 35 parts by weight, the usage amount of the isocyanate is 8 to 14 parts by weight, the usage amount of the second polyether polyol is 45 to 65 parts by weight, and the usage amount of the blocking agent is 3 to 6 parts by weight. Preferably, the usage amount of the blocking agent is 3 to 5 parts by weight.

In the second polymer forming step S120 of other embodiments, a chain extender is further added, and the first polymer, the second polyester polyol, and the chain extender jointly form the second polymer. Based on 100 parts by weight of the polyurethane resin, a usage amount of the chain extender is within a range from 0 to 3 parts by weight. Further, the chain extender is at least one selected from the group consisting of ethylene glycol, 1,4-butanediol, and 1,6-hexanediol. Preferably, the usage amount of the chain extender is 0.01 to 3 parts by weight.

In the present embodiment, a number average molecular weight of the first polymer is within a range from 10,000 to 20,000, and a number average molecular weight of the second polymer is within a range from 20,000 to 30,000, but the present disclosure is no limited thereto. Preferably, the second polyether polyol is further limited to being a long chain polyether polyol, the second polyether polyol includes a plurality of repeating units, each of the repeating units is at least one selected from the group consisting of ethylene glycol, propylene glycol, and butylene glycol, and the quantity of the repeating units included by the second polyether polyol is within a range from 10 to 110. However, the present disclosure is not limited thereto.

In addition, in the present embodiment, the first polyether polyol is at least one selected from the group consisting of ethylene glycol, propylene glycol, and butylene glycol, the isocyanate is at least one selected from the group consisting of diphenylmethane diisocyanate, toluene diisocyanate, and isophorone diisocyanate, and the second polyether polyol is at least one selected from the group consisting of polyethylene glycol, polypropylene glycol, and polybutylene glycol. However, the present disclosure is not limited thereto. Moreover, in the present embodiment, the blocking agent is at least one selected from the group consisting of 2-butanone oxime, 2,2-dimethoxypropane, and caprolactam, but the present disclosure is not limited thereto.

### Polyurethane Resin

The present disclosure further provides a polyurethane resin, and the polyurethane resin is not limited to being produced by the above-mentioned method. The polyurethane resin includes a first polyester polyol, an isocyanate, a second polyester polyol, and a blocking agent. A usage amount ratio among a usage amount of the first polyether polyol, a usage amount of the second polyether polyol, and a usage amount of the blocking agent is within a range from 35:59:6 to 27:70:3. A degree of crosslinking of the polyurethane resin is within a range from 2.2 to 2.5.

Based on 100 parts by weight of the polyurethane resin, the usage amount of the first polyether polyol is 22 to 35 parts by weight, the usage amount of the isocyanate is 8 to 14 parts by weight, the usage amount of the second polyether polyol is 45 to 65 parts by weight, and the usage amount of the blocking agent is 3 to 6 parts by weight. Preferably, the usage amount of the blocking agent is 3 to 5 parts by weight.

The polyurethane resin can further include a chain extender. Based on 100 parts by weight of the polyurethane resin, a usage amount of the chain extender is 0 to 3 parts by weight. Further, the chain extender is at least one selected from the group consisting of ethylene glycol, 1,4-butanediol, and 1,6-hexanediol. Preferably, the usage amount of the chain extender is 0.01 to 3 parts by weight.

A hydroxyl functionality of the first polyether polyol is less than a hydroxyl functionality of the second polyether polyol. Preferably, the hydroxyl functionality of the first polyether polyol is 2, and the hydroxyl functionality of the second polyether polyol is within a range from 3 to 4. More preferably, the hydroxyl functionality of the first polyether polyol is 2, and the hydroxyl functionality of the second polyether polyol is 3.

Preferably, the second polyether polyol is further limited to being a long chain polyether polyol, the second polyether polyol includes a plurality of repeating units, each of the repeating units is at least one selected from the group consisting of ethylene glycol, propylene glycol, and butylene glycol, and the quantity of the repeating units included by the second polyether polyol is within a range from 10 to 110. However, the present disclosure is not limited thereto.

In addition, in the present embodiment, the first polyether polyol is at least one selected from the group consisting of ethylene glycol, propylene glycol, and butylene glycol, the isocyanate is at least one selected from the group consisting of diphenylmethane diisocyanate, toluene diisocyanate, and isophorone diisocyanate, and the second polyether polyol is at least one selected from the group consisting of polyethylene glycol, polypropylene glycol, and polybutylene glycol. However, the present disclosure is not limited thereto. Moreover, in the present embodiment, the blocking agent is at least one selected from the group consisting of 2-butanone oxime, 2,2-dimethoxypropane, and caprolactam, but the present disclosure is not limited thereto.

### Experimental Results

Hereinafter, a more detailed description will be provided with reference to Exemplary Examples 1 to 4 and Comparative Examples 1 to 3. However, the Exemplary Examples below are only used to aid in understanding of the present disclosure, and are not to be construed as limiting the scope of the present disclosure.

Exemplary Example 1 is produced in the following manner. 81 g (0.04 moles) of polypropylene glycol (DL2000, MW=2000) and 162 g (0.027 moles) of polyglycerol (PC6000, MW=6000) are added into a reaction tank and are evenly stirred with a temperature being raised to 70° C., and then 36.6 g (0.21 moles) of toluene diisocyanate (TDI) and a small amount of a bismuth acid catalyst are added with the temperature being raised to 78° C. for reaction for 2 hours (step 1). 5.4 g (0.046 moles) of 1,6-hexylene glycol (1,6-HG) is further added to be continuously reacted at 78° C. for 1.5 hours (step 2). Then, the temperature is reduced to be below 45° C., and 14.5 g (0.167 moles) of butanone oxime (MEKO) is added to carry out an NCO group blocking reaction for about 1 hour (step 3).

Exemplary Example 2 is produced in the following manner. 84 g (0.042 moles) of polypropylene glycol (DL2000, MW=2000) and 168 g (0.028 moles) of polyglycerol (PC6000, MW=6000) are added into a reaction tank and are evenly stirred with a temperature being raised to 70° C., and then 31.8 g (0.183 moles) of toluene diisocyanate (TDI) and a small amount of a bismuth acid catalyst are added with temperature being raised to 78° C. for reaction for 2 hours (step 1). 2.7 g (0.023 moles) of 1,6-hexylene glycol (1,6-HG) is further added to be continuously reacted at 78° C. for 1.5 hours (step 2). Then, the temperature is reduced to be below 45° C., and 13.2 g (0.152 moles) of butanone oxime (MEKO) is added to carry out an NCO group blocking reaction for about 1 hour (step 3).

Exemplary Example 3 is produced in the following manner. 88 g (0.044 moles) of polypropylene glycol (DL2000, MW=2000) and 117 g (0.0195 moles) of polyglycerol (PC6000, MW=6000) are added into a reaction tank and are evenly stirred with a temperature being raised to 70° C., and then 26.1 g (0.183 moles) of toluene diisocyanate (TDI) and a small amount of a bismuth acid catalyst are added with the temperature being raised to 78° C. for reaction for 2 hours (step 1). 60 g (0.01 moles) of polyglycerol (PC6000, MW=6000) is added to be continuously reacted at 78° C. for 1.5 hours (step 2). Then, the temperature is reduced to be below 45° C., and 11.4 g (0.131 moles) of butanone oxime (MEKO) is added to carry out an NCO group blocking reaction for about 1 hour (step 3).

Exemplary Example 4 is produced in the following manner. 78 g (0.039 moles) of polypropylene glycol (DL2000, MW=2000) and 174 g (0.029 moles) of polyglycerol (PC6000, MW=6000) are added into a reaction tank and are evenly stirred with a temperature being raised to 70° C., and then 26.4 g (0.152 mole) of toluene diisocyanate (TDI) and a small amount of a bismuth acid catalyst are added with the temperature being raised to 78° C. for reaction for 2 hours (step 1). 11 g (0.0037 moles) of polyglycerol (PC3000, MW=3000) is further added to be continuously reacted at 78° C. for 1.5 hours (step 2). Then, the temperature is reduced to be below 45° C., and 10.8 g (0.124 moles) of butanone oxime (MEKO) is added to carry out an NCO group blocking reaction for about 1 hour (step 3).

Comparative Example 1 is produced in the following manner. 101 g (0.05 moles) of polypropylene glycol (DL2000, MW=2000) and 135 g (0.0225 moles) of polyglycerol (PC6000, MW=6000) are added into a reaction tank and are evenly stirred with a temperature being raised to 70° C., and then 40.5 g (0.233 moles) of toluene diisocyanate (TDI) and a small amount of a bismuth acid catalyst are added, and the temperature is raised to 78° C. for reaction for 2 hours (step 1). 6.9 g (0.058 moles) of 1,6-hexylene glycol (1,6-HG) is further added to be continuously reacted at 78° C. for 1.5 hours (step 2). Then, the temperature is reduced to be below 45° C., and 0.22 g (19.2 moles) of butanone oxime (MEKO) is added to carry out an NCO group blocking reaction for 1 hour (step 3).

Comparative Example 2 is produced in the following manner. 78 g (0.039 moles) of polypropylene glycol (DL2000, MW=2000) and 156 g (0.026 moles) of polyglycerol (PC6000, MW=6000) are added into a reaction tank and are evenly stirred with a temperature being raised to 70° C., and then 41.4 g (0.238 moles) of toluene diisocyanate (TDI) and a small amount of a bismuth acid catalyst are added with the temperature being raised to 78° C. for reaction for 2 hours (step 1). 6.9 g (0.058 moles) of 1,6-hexylene glycol (1,6-HG) is further added to be continuously reacted at 78° C. for 1.5 hours (step 2). Then, the temperature is reduced to be below 45° C., and 17.7 g (0.204 mole) of butanone oxime (MEKO) is added to carry out an NCO group blocking reaction for about 1 hour (step 3).

Comparative example 3 is implemented as follows. 60 g (0.03 mole) of polypropylene glycol (DL2000, MW=2000), 13.5 g (0.0135 mole) of polypropylene glycol (DL1000, MW=1000), and 114 g (0.038 mole) of polyglycerol (PC3000, MW=3000) are added into a reaction tank and are evenly stirred with a temperature being raised to 70° C., 39.3 g (0.226 mole) of toluene diisocyanate (TDI) and a small amount of a bismuth acid catalyst are added with the temperature being raised to 78° C. for reaction for 2 hours (step 1). 55.5 g (0.0185 mole) of polyglycerol (PC3000, MW=3000) is further added to be continuously reacted at 78° C. for 1.5 hours (step 2). The temperature is reduced to be below 45° C., and 16.8 g (0.193 moles) of butanone oxime (MEKO) is added to carry out an NCO group blocking reaction for about 1 hour (step 3).

Components, viscosity, a degree of crosslinking, a bubble amount, a low-temperature bending resistance, and an odor of each of the polyurethane resins of Exemplary Examples 1 to 4 and Comparative Examples 1 to 3 are listed in the Table 1 below, and relevant testing methods are described as follows.

A viscosity test is carried out through use of a viscometer.

A crosslinking test is carried out through Fourier-transform infrared spectroscopy (FT-IR) and nuclear magnetic resonance (NMR).

A bubble amount test is carried out by having a same amount of a sample stirred at 600 rpm for 3 minutes and set aside for 1 hour before measuring the bubble amount thereof.

A low-temperature bending resistance test is carried out by using a bending resistance testing machine (GT-7006-V50) to perform a bending test at an angle of 22.5 degrees, a frequency of 100 times/minute, and a temperature of −30° C. for 30,000 times.

An odor test is carried out through SGS testing.

TABLE 1
[Examples and Test Results of Their Physical and Chemical Properties]

| | | Exemplary | Exemplary | Exemplary | Exemplary |
|---|---|---|---|---|---|
| Item | | Example 1 | Example 2 | Example 3 | Example 4 |
| Parameter | usage amount of | 27.1 | 28 | 29.3 | 26.1 |
| of each | first polyether | | | | |
| component | polyol (wt %) | | | | |
| | usage amount of | 12.2 | 10.6 | 8.7 | 8.8 |
| | isocyanate (wt %) | | | | |
| | usage amount of | 54.1 | 56.1 | 58.5 | 61.4 |
| | second polyether | | | | |
| | polyol (wt %) | | | | |
| | usage amount of | 4.8 | 4.4 | 3.5 | 3.6 |
| | blocking agent (wt %) | | | | |
| | usage amount of | 1.8 | 0.9 | 0 | 0 |
| | chain extender (wt %) | | | | |
| | usage amount ratio | 31.5/62.9/5.6 | 32/63/5 | 32/64.2/3.8 | 28/68/4 |
| | of usage amounts of | | | | |
| | first polyether polyol, | | | | |
| | second polyether polyol, | | | | |
| | and blocking agent | | | | |
| | hydroxyl functionality of | 2 | 2 | 2 | 2 |
| | first polyester polyol | | | | |
| | hydroxyl functionality of | 3 | 3 | 3 | 3 |
| | second polyester polyol | | | | |
| Test | viscosity of polyurethane | 26500 | 22500 | 19500 | 18500 |
| results | resin | | | | |
| | degree of crosslinking | 2.23 | 2.3 | 2.4 | 2.45 |
| | of polyurethane resin | | | | |
| | bubble amount of | 10 | 8 | 5 | 5 |
| | polyurethane resin | | | | |
| | (within 30 minutes) | | | | |
| | low-temperature bending | OK | OK | OK | OK |
| | resistance of polyurethane | | | | |
| | resin (30,000 times | | | | |
| | at −30° C.) | | | | |
| | odor of polyurethane | 3.5 | 3.5 | 3 | 3 |
| | resin (level) | | | | |

| | | Comparative | Comparative | Comparative |
|---|---|---|---|---|
| Item | | Example 1 | Example 2 | Example 3 |
| Parameter | usage amount of | 33.7 | 26 | 24.8 |
| of each | first polyether | | | |
| component | polyol (wt %) | | | |
| | usage amount of | 13.5 | 13.8 | 13.1 |
| | isocyanate (wt %) | | | |
| | usage amount of | 44.9 | 52 | 56.5 |
| | second polyether | | | |
| | polyol (wt %) | | | |
| | usage amount of | 6.4 | 5.9 | 5.6 |
| | blocking agent (wt %) | | | |
| | usage amount of | 1.5 | 2.3 | 0 |
| | chain extender (wt %) | | | |
| | usage amount ratio | 39.7/52.8/7.5 | 31/62/7 | 28.5/65/6.5 |
| | of usage amounts of | | | |
| | first polyether polyol, | | | |
| | second polyether polyol, | | | |
| | and blocking agent | | | |
| | hydroxyl functionality of | 2 | 2 | 2 |
| | first polyester polyol | | | |
| | hydroxyl functionality of | 3 | 3 | 3 |
| | second polyester polyol | | | |
| Test | viscosity of polyurethane | 31500 | 30300 | 24500 |
| results | resin | | | |
| | degree of crosslinking | 2.2 | 2.2 | 2.56 |
| | of polyurethane resin | | | |
| | bubble amount of | 30 | 30 | 15 |
| | polyurethane resin | | | |
| | (within 30 minutes) | | | |
| | low-temperature bending | NG | NG | NG |
| | resistance of polyurethane | | | |
| | resin (30,000 times | | | |
| | at −30° C.) | | | |
| | odor of polyurethane | 4.5 | 4 | 4 |
| | resin (level) | | | |

### Discussion of Test Results

Due to having few bubbles, a low odor, and an excellent low-temperature bending resistance, the polyurethane resins of Exemplary Examples 3 and 4 are the best resins for producing artificial leather that is soft and low in odor and has an excellent tactile sensation.

The polyurethane resins of Comparative Examples 1 to 3 have a heavy odor and a poor low-temperature bending resistance, and are thus not suitable for being used as resins for vehicle artificial leather.

### Beneficial Effects of the Embodiment

In conclusion, in the polyurethane resin and the method for producing the same provided by the present disclosure, by virtue of a hydroxyl functionality of the first polyether polyol being less than a hydroxyl functionality of the second polyether polyol, and a usage amount ratio of a usage amount of the first polyether polyol to a usage amount of the second polyether polyol to a usage amount of the blocking agent being within a range from 35:59:6 to 27:70:3, the polyurethane resin that is finally formed can exhibit properties such as having few bubbles, an excellent low temperature bending resistance, and a low odor.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a polyurethane resin, comprising:
a first polymer forming step implemented by reacting a first polyether polyol and an isocyanate to form a first polymer;
a second polymer forming step implemented by reacting the first polymer and a second polyether polyol to form a second polymer, wherein a hydroxyl functionality of the first polyether polyol is less than a hydroxyl functionality of the second polyether polyol; and
a blocking step implemented by adding a blocking agent into the second polymer to form the polyurethane resin;
wherein a usage amount ratio of a usage amount of the first polyether polyol to a usage amount of the second polyether polyol to a usage amount of the blocking agent is within a range from 35:59:6 to 27:70:3;
wherein a degree of crosslinking of the polyurethane resin is within a range from 2.2 to 2.5.

2. The method according to claim 1, wherein, based on 100 parts by weight of the polyurethane resin, the usage amount of the first polyether polyol is 25 to 35 parts by weight, a usage amount of the isocyanate is 8 to 14 parts by weight, the usage amount of the second polyether polyol is 45 to 65 parts by weight, and the usage amount of the blocking agent is 3 to 6 parts by weight.

3. The method according to claim 1, wherein a chain extender is further added in the second polymer forming step, and the first polymer, the second polyether polyol, and the chain extender jointly react and form the second polymer; wherein, based on 100 parts by weight of the polyurethane resin, a usage amount of the chain extender is 0 to 3 parts by weight; wherein the chain extender is at least one selected from the group consisting of ethylene glycol, 1,4-butanediol, and 1,6-hexanediol.

4. The method according to claim 1, wherein the hydroxyl functionality of the first polyether polyol is 2, and the hydroxyl functionality of the second polyether polyol is within a range from 3 to 4.

5. The method according to claim 4, wherein the hydroxyl functionality of the second polyether polyol is 3.

6. The method according to claim 1, wherein a number average molecular weight of the first polymer is within a range from 10,000 to 20,000, and a number average molecular weight of the second polymer is within a range from 20,000 to 30,000.

7. The method according to claim 1, wherein the second polyether polyol is further limited to being a long chain polyether polyol, the second polyether polyol includes a plurality of repeating units, and each of the repeating units is at least one selected from the group consisting of ethylene glycol, propylene glycol, and butylene glycol; wherein a quantity of the repeating units included in the second polyether polyol is within a range from 10 to 110.

8. The method according to claim 1, wherein the first polyether polyol is at least one selected from the group consisting of ethylene glycol, propylene glycol, and butylene glycol, the isocyanate is at least one selected from the group consisting of diphenylmethane diisocyanate, toluene diisocyanate, and isophorone diisocyanate, and the second polyether polyol is at least one selected from the group consisting of polyethylene glycol, polypropylene glycol, and polybutylene glycol.

9. A polyurethane resin, comprising:
a first polyether polyol;
an isocyanate;
a second polyether polyol, wherein a hydroxyl functionality of the first polyether polyol is less than a hydroxyl functionality of the second polyether polyol; and
a blocking agent;
wherein a usage amount ratio of a usage amount of the first polyether polyol to a usage amount of the second polyether polyol to a usage amount of the blocking agent is within a range from 35:59:6 to 27:70:3;
wherein a degree of crosslinking of the polyurethane resin is within a range from 2.2 to 2.5.

10. The polyurethane resin according to claim 9, wherein, based on 100 parts by weight of the polyurethane resin, the usage amount of the first polyether polyol is 25 to 35 parts by weight, a usage amount of the isocyanate is 8 to 14 parts by weight, the usage amount of the second polyether polyol is 45 to 65 parts by weight, and the usage amount of the blocking agent is 3 to 6 parts by weight.

11. The polyurethane resin according to claim 9, further comprising a chain extender, wherein, based on 100 parts by weight of the polyurethane resin, a usage amount of the chain extender is 0 to 3 parts by weight; wherein the chain extender is at least one selected from the group consisting of ethylene glycol, 1,4-butanediol, and 1,6-hexanediol.

12. The polyurethane resin according to claim 9, wherein the hydroxyl functionality of the first polyether polyol is 2, and the hydroxyl functionality of the second polyether polyol is within a range from 3 to 4.

13. The polyurethane resin according to claim 12, wherein the hydroxyl functionality of the second polyether polyol is 3.

14. The polyurethane resin according to claim 9, wherein the second polyether polyol is further limited to being a long chain polyether polyol, the second polyether polyol includes a plurality of repeating units, and each of the repeating units is at least one selected from the group consisting of ethylene glycol, propylene glycol, and butylene glycol, and wherein a quantity of the repeating units included in the second polyether polyol is within a range from 10 to 110.

15. The polyurethane resin according to claim 9, wherein the first polyether polyol is at least one selected from the group consisting of ethylene glycol, propylene glycol, and butylene glycol, the isocyanate is at least one selected from the group consisting of diphenylmethane diisocyanate, toluene diisocyanate, and isophorone diisocyanate, and the second polyether polyol is at least one selected from the group consisting of polyethylene glycol, polypropylene glycol, and polybutylene glycol.
